(19) United States
(12) Patent Application Publication
(10) Pub. No.: US 2004/0161226 A1
(43) Pub. Date: Aug. 19, 2004

(54) Integrated audio / video recorder with magnetic and optical data storage

(76) Inventor: Scott Edward Watson, San Jose, CA (US)

Correspondence Address: Scott Edward Watson, 4841 Winton Way, San Jose, CA, 95124, US

(21) Appl. No.: 10/762,033

(22) Filed: Jan. 20, 2004

Related U.S. Application Data
(60) Provisional application No. 60/441,840, filed on Jan. 21, 2003.

(51) Int. Cl. H04N 5/781

(52) U.S. Cl. 386/125; 386/126

(57) ABSTRACT

An integrated audio/video recorder combines an audio/video recorder processor with magnetic data storage and optical data storage. The high speed an large capacity of magnetic data storage complements the low-cost, removable and robust features of optical data storage. The integrated recorder eliminates many redundant components. The integrated recorder utilizes a single printed circuit board 525 to connect a magnetic data storage microprocessor 120, an optical data storage microprocessor 220 and an audio/video recorder microprocessor 320.

### CROSS-REFERENCE TO RELATED APPLICATIONS

This application claims the benefit of Provisional Patent Application Ser. No. 60/441840 filed 2003 Jan. 21.

### FEDERALLY SPONSORED RESEARCH

Not Applicable.

### SEQUENCE LISTING

Not Applicable.

### BACKGROUND

1. Field of Invention

This invention integrates an audio/video recorder processor, along with a magnetic data storage device and an optical data storage device, simplifying the structure of the audio/video recorder while increasing reliability.

2. Description of Prior Art

Today, there are many devices for recording, storing and manipulating audio and video data. Older analog devices such as audio cassette tape recorders or video cassette tape recorders (VCRs) are still in wide use. Analog devices continue to be replaced by newer digital technologies, such as Compact Disk (CD) and Digital Audio Tape (DAT) for audio applications; Video-CD (V-CD) and Digital Video Disks (DVD) for video applications. CDs, V-CD and DVDs are optical disks, and early-on, these were all pre-recorded. Now, recordable CD and DVD devices are giving consumers the ability to record their own audio or video data to optical disk. At the same time, Digital Video Recorders (DVR) have been introduced which record video to a fixed Hard Disk Drive (HDD). HDDs utilize a magnetic means of recording, similar to magnet tape.

A DVD can only hold a standardized 4.7 gigabytes (GB) of data on a single sided DVD disk. This capacity yields approximately 2 hours of video. The DVD disk is removable, robust and very inexpensive. DVD disks can be removed and played in other DVD players, allowing DVD disks to be archived or shared with others. Video can be directly recorded to the DVD, but it can only be written once. Prior to recording to a DVD disk, the user must ensure that a blank DVD is present in the DVD recorder first. An “instant record” function is very important to users who suddenly decide to record video from live broadcasts. Most users find it hard to keep a blank DVD in the DVD recorder at all times. Editing a DVD is limited re-sequencing video data on the DVD; video cannot be erased and replaced. The small capacity of a DVD disk and the write-once capability limits the capabilities of a DVD recorder.

Today, a single HDD can hold 200 GBs, storing much more video data than a single DVD. In a PVR, video can be recorded directly to the HDD. HDD recording and replay speeds are so fast than more than one video stream can be recorded or played simultaneously. One stream of video can be recorded, while another video stream is played back. HDDs can be recorded, erased and re-recorder many times. Hence, HDDs allow quick editing of video data. While a PVR device costs about the same as a DVD recorder, the HDD utilize fixed disks inside a sealed housing. Since HDD disks are not removable, they cannot be archived or played on other DVRs. The entire HDD device could be removed, but the HDD device is much more expensive than a single DVD disk and is more fragile. Hence, PVR video data cannot be easily or cheaply shared with others.

While these digital devices compete with each other for market dominance, it can be seen that the functions of a recordable DVD and DVR with a HDD are more complementary. Combining a DVD recorder and an HDD into a single video recorder device can utilize the advantages of each. The HDD can quickly record vast amounts of video, while the DVD recorder can write DVD disks which can be removed for archiving and play on different DVD players. The HDD allows “instant record” of multiple video streams, even while the DVD is recording or playing video on a DVD disk. For editing video, it is more flexible to record to the HDD, edit the data, insert a blank DVD disk and then record a final, edited copy of audio and video, which can then be removed. Video recorders with both a DVD recorder and HDD are now on the market.

A prior art audio/video recorder with both a HDD and DVD is illustrated in FIG. 1. Controlling the audio/video recorder 10 is an audio/video recorder processor electronics circuitry 300. A front panel controller 403 provides an interface to the user of the recorder 10. The controller 403 is connected to the circuitry 300 via a front panel controller connector 307. The circuitry 300 can receive audio and video inputs from different external sources: video input connector 301, audio input connector 302, or a digital audio/video interface connector 303, such as described by the IEEE (Institute of Electrical and Electronics Engineers) 1394 standard. A radio frequency tuner 402, connected to an antenna 401, may supply video and audio inputs via the video input connector 301 and audio input connector 302. The circuitry 300 can output audio and video through the interface connector 303, an audio output connector 305, a video output connector 306, or a standard audio interface connector 304, such as described by the IEC (International Electrotechnical Commission) 958 standard. The circuitry 300 can retrieve or store audio and video data on an HDD 100 or a DVD 200. The circuitry 300 includes an HDD interface connector 322, which connects to an HDD interface cable 405, which connects to the HDD 100. The circuitry 300 also includes a DVD interface connector 319, which connects to a DVD interface cable 406, which connects to the DVD 200. A direct-current power supply 404 provides electronic power to the HDD 100 through an HDD power connector 123, the DVD 200 through a DVD power connector 223, the circuitry 300 through a power connector 323, the front panel controller 403, and the tuner 402.

FIG. 2 depicts the details of a prior art audio/video recorder processor electronics circuitry 300. User commands are passed from the front panel controller 403 to an audio/video recorder processor 320 via the connector 307. Via the connector 301, a video input converter 328 converts the video signal from a standard such as NTSC (National Television Standards Committee) or PAL (Phase Alternation by Line) to a digital signal which is sent to the processor 320. Via the connector 302, an ADC (analog-to-digital conversion) audio input converter 327 converts the audio signal to a digital signal which is sent to the processor 320. A digital audio/video standard interface 326 receives and sends digital video between the processor 320 and connector 303. An audio standard interface 329 receives digital audio from the processor 320 and outputs a signal to the connector 304. A DAC (digital-to-analog conversion) audio output converter 330 receives digital audio from the processor 320 and outputs an analog signal to the connector 305. A video output converter 331 converts digital video from the processor 320 to an analog or digital video standard and outputs the signal to connector 306.

The processor 320 operates on coded instructions which are stored in a non-volatile memory 317. Volatile memory 318 is used by the processor 320 for short-term storage of digital audio and video data. A timing generator 324 provides an accurate and consistent timing signal to the processor 320. A power connector 323 receives DC power and passes it to a power regulator 321 which regulates the power to an accurate and consistent voltage. A printed circuit board 325 provides electronic interconnection between all of the components of the circuitry 300. Completing the components of the circuitry 300 are the HDD interface connector 322 and DVD interface connector 319.

A prior art HDD is illustrated in FIG. 3. The HDD 100 contains a magnetic disk 111 on which data is recorded. The magnetic disk 111 is mounted onto and rotated by a spindle motor 113. A magnetic head 112 writes and reads data onto the disk 111. The head 112 is mounted on a positioner 114. The motor 113 and positioner 114 are controlled by a servo controller 116 and a microprocessor 120. A timing generator 124 provides accurate time interval information to the microprocessor 120. The read channel 115 provides encoding and decoding of digital data between the head 112 and microprocessor 120. The microprocessor command codes are stored in a non-volatile memory 117. The microprocessor 120 caches data in a volatile memory 118 during operation. The microprocessor receives commands and communicates with the host system via the interface connector 122. A power regulator 121 ensures proper conditioning of the power supplied by the host system through the power connector 123. A printed circuit board 125 provides interconnecting circuitry between the interface connector 122, power connector 123, microprocessor 120, power regulator 121, timing generator 124, volatile memory 118, non-volatile memory 117, servo controller 116, and read channel 115.

A prior art DVD is illustrated in FIG. 4. The DVD 200 utilizes an optical disk 211 on which data is recorded. The disk 211 is mounted onto and rotated by a spindle motor 213. An optical head 212 writes and reads data onto the disk 211. The head 212 is mounted on a positioner 214. The motor 213 and positioner 214 are controlled by a servo controller 216 and a microprocessor 220. A timing generator 224 provides accurate time interval information to the microprocessor 220. A read channel 215 provides encoding and decoding of digital data between the head 212 and the microprocessor 220. The microprocessor command codes are stored in a non-volatile memory 217. The microprocessor 220 caches data in a volatile memory 218 during operation. The microprocessor receives commands and communicates with the host system via the interface connector 222. A power regulator 221 ensures proper conditioning of the power supplied by the host system through the power connector 223. A printed circuit board 225 provides interconnecting circuitry between the interface connector 222, power connector 223, microprocessor 220, power regulator 221, timing generator 224, volatile memory 218, non-volatile memory 217, servo controller 216, and read channel 215.

Design Redundancies

It is easy to see strong similarities between the HDD and DVD devices. Some of these similar components are actually quite different in design due to different requirements of magnetic data storage and optical data storage. For example, redundant spindle motors are necessitated by different design requirements. While the HDD motor must rigidly hold a magnetic disk inside a sealed environment with materials carefully selected to control corrosion and contamination. The DVD motor generally allows removal of an optical data disk and hence must be open to the outside environment. As a second example, the redundancy of microprocessors has generally been necessitated by differences in data formats and methods of positioning the read/write elements over the data disks.

Other components are almost identical designs. The host interface connector is exactly the same, since standards such as the IDE (Intelligent Drive Electronics) interface are adopted to simplify integration into various electronic devices. Electronic power requirements are also identical, as many consumer electronic devices and most peripheral devices have been standardized to 5 and 12 volts DC operation. Power regulation requirements are also the same, as integrated circuits are mostly designed to the same tolerances on voltage. Timing generator requirements are also generally the same, as the core microprocessors are designed to standard operating frequencies, for example: 27 megahertz (MHz). Printed circuit boards designs are very much the same, since power and data-carrying requirements are similar.

Further, the audio/video recorder processor electronics circuitry contains many of the same components as the HDD and DVD: volatile memory, non-volatile memory, timing generator, power regulator, power connector and mating interface connectors for both the HDD and DVD.

System Reliability

When an audio/video recording device is built with a discrete HDD and discrete DVD, several redundant internal components are employed along with a large number of electrical interconnects. For example, standard HDD and DVD interfaces employ 40 electrical lines. Between the HDD microprocessor 120 and the audio/video recorder processor 320, there are 4 solder connections, 2 mechanical contacts within the interface cable connectors, and 2 mechanical contacts internal to the interface cable, totaling 8 distinct connections for each of the 40 lines. The DVD interface is similar. This yields 640 electrical unions for connecting both the HDD and DVD, each representing a possible failure point. Hence, the large number of electrical interconnects and large number of components provide many possible failure points, resulting in low system reliability. This large number of components and interconnects also adds significantly to overall system cost.

An audio/video recording device with a discrete HDD and discrete DVD further requires a separate mounting structure for each of these devices. This adds to the weight, volume, and number of components in the overall system. It also adds to product development time, manufacturing assembly time, and overall system cost. These additional application-specific components provide more possible failure points, further decreasing the reliability of the overall system.

Objects and Advantages

The current invention integrates the audio/video processor circuitry, the HDD and the DVD components into a single device. This device takes advantage of the complimentary features of a PVR and a DVD recorder/player. The PVR functionality allows “instant recording” of video onto a large capacity HDD, even if the DVD is playing a DVD disk. Video can be easily edited on the HDD and then recorded to a DVD disk when it is in its final form. DVD disks can be archived or played on other DVD players.

This integrated device reduces the total number of components and electrical interconnects. This results in increased system reliability, lower weight and volume, and lower overall system cost.

The integrated device can utilize a standardized shape and size, along with already standardized audio and video interfaces, to simplify its use in different products. For example, a stand-alone audio/video recorder, a cable or satellite receiver, a television, a security camera system or even an automobile can quickly and easily incorporate this integrated audio/video recorder.

### SUMMARY OF INVENTION

The present invention integrates audio/video recorder processor electronics circuitry with a magnetic data storage device, and an optical data storage device to improve reliability, reduce the overall number of components, allow a reduction in overall weight and volume, and reduce overall system cost.

This invention may be regarded as an integrated audio/video recorder device with embedded HDD and DVD functions. External connections are limited to the necessary audio/video input and output connections and interfaces, along with a front panel controller interface and power connection. Serving the audio/video recorder processor circuitry, HDD components, and DVD components are a single power supply connection, a single power regulator, a single timing generator, a single non-volatile memory, a single volatile memory, a single printed circuit board, and a single mounting means.

### BRIEF DESCRIPTION OF DRAWINGS

FIG. 1 schematically shows the architecture of a prior-art audio/video recording device with a discrete HDD device and DVD device.

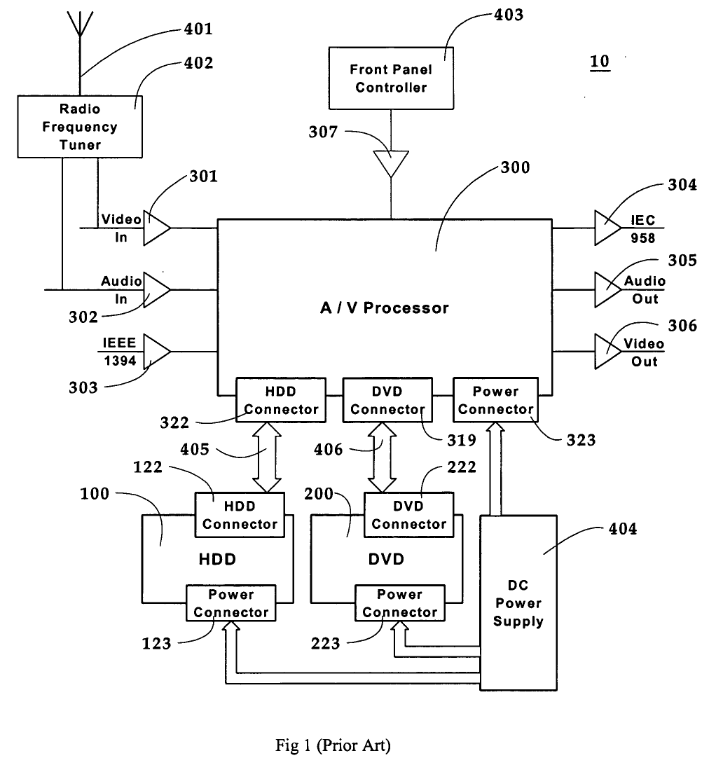

FIG. 2 schematically shows the architecture of a prior-art audio/video recorder processor electronics circuitry.

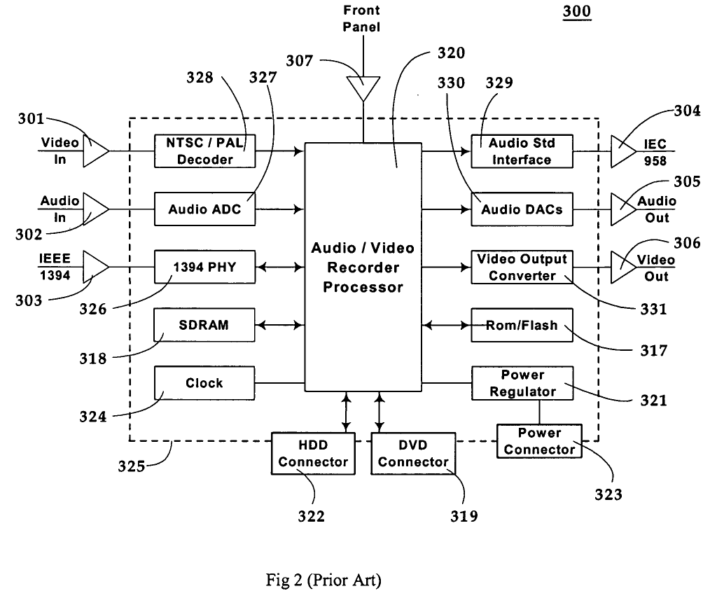

FIG. 3 schematically shows the architecture of a prior-art HDD device.

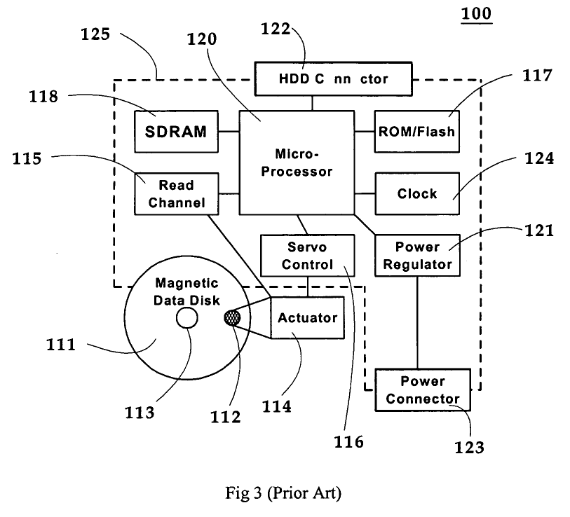

FIG. 4 schematically shows the architecture of a prior-art DVD device.

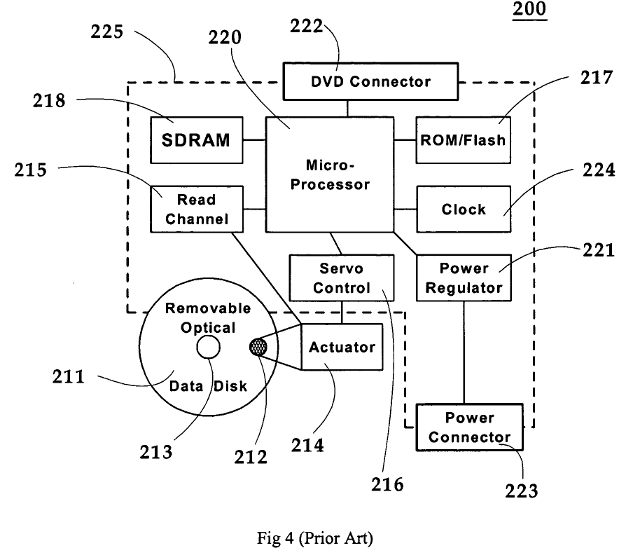

FIG. 5 schematically shows the architecture of an integrated audio/video recording device containing embedded HDD and DVD functions.

FIG. 6 schematically shows the architecture of an integrated audio/video recorder processor electronics circuitry with embedded HDD and DVD components.

### DESCRIPTION OF THE PREFERRED EMBODIMENT

10 Audio/video recorder

100 HDD

111 Magnetic disk

112 Magnetic head

113 Spindle motor

114 Positioner

115 Read channel

116 Servo controller

117 Non-volatile memory

118 Volatile memory

120 Microprocessor

121 Power regulator

122 Interface connector

123 Power connector

124 Timing generator

125 Printed circuit board

200 DVD

211 Optical disk

212 Optical head

213 Spindle motor

214 Positioner

215 Read channel

216 Servo controller

217 Non-volatile memory

218 Volatile memory

220 Microprocessor

221 Power regulator

222 Interface connector

223 Power connector

224 Timing generator

225 Printed circuit board

300 Audio/video recorder processor electronics circuitry

301 Video input connector

302 Audio input connector

303 Digital audio/video interface connector

304 Standard audio interface connector

305 Audio output connector

306 Video output connector

307 Front panel controller connector

317 Non-volatile memory

318 Volatile memory

319 DVD interface connector

320 Audio/video recorder processor

321 Power regulator

322 HDD interface connector

323 Power connector

324 Timing generator

325 Printed circuit board

326 Digital audio/video standard interface

327 Audio input converter

328 Video input converter

329 Audio standard interface

330 Audio output converter

331 Video output converter

401 Antenna

402 Radio frequency tuner

403 Front panel controller

404 Direct-current power supply

405 HDD interface cable

406 DVD interface cable

500 Integrated audio/video recorder processor circuitry

517 Non-volatile memory

518 Volatile memory

521 Power regulator

523 Power connector

524 Timing generator

525 Printed circuit board

### DETAILED DESCRIPTION:

### Description—Preferred Embodiment

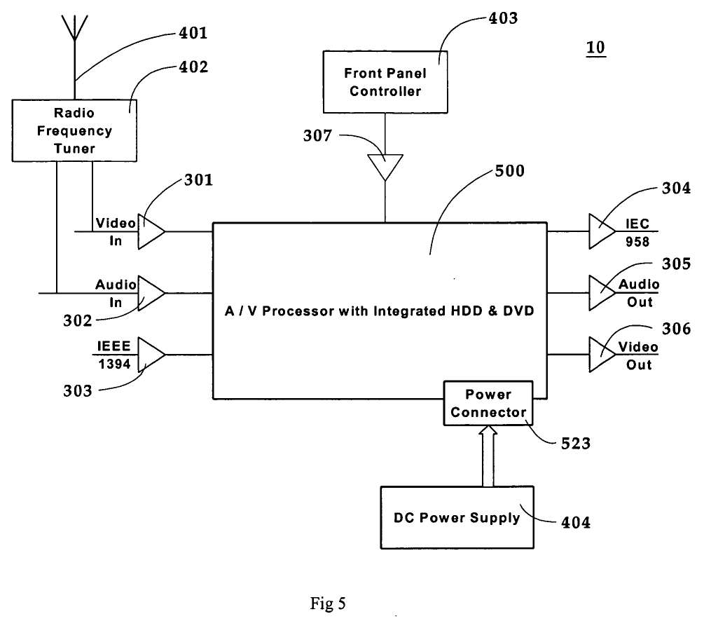

FIG. 5 is a schematic of the architecture of an audio/video recorder device 10 utilizing an integrated audio/video recorder processor circuitry 500 containing embedded HDD and DVD functions. The circuitry 500 retains the video input connector 301, audio input connector 302, digital audio/video interface connector 303, standard audio interface connector 304, audio output connector 305, video output connector 306 and front panel controller connector 307. A single power connector 523 provides power to the circuitry 500.

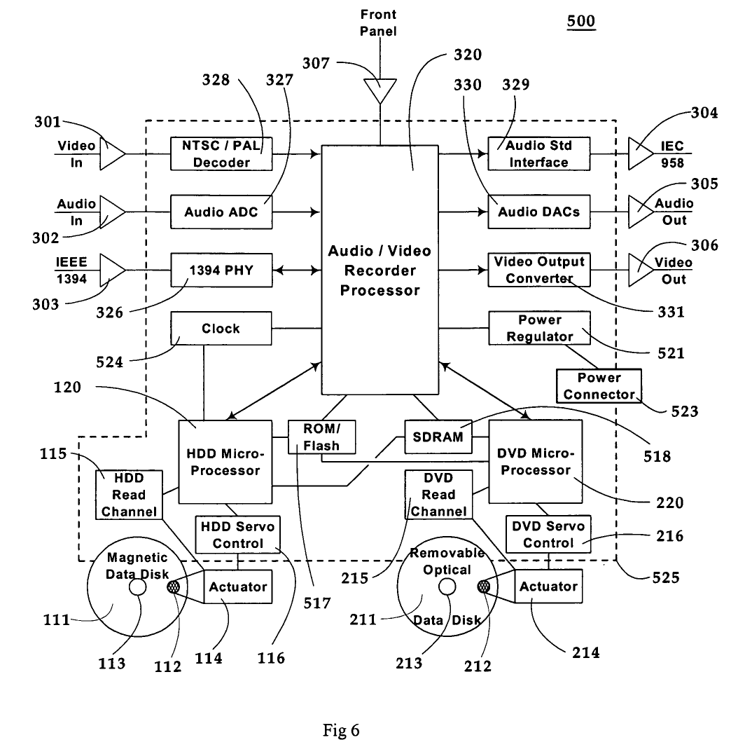

FIG. 6 is a schematic of the architecture of an integrated audio/video recorder processor electronics circuitry 500. A single printed circuit board 525 provides interconnecting circuitry between the power connector 523, a power regulator 521, a timing generator 524, a volatile memory 518, a non-volatile memory 517, the audio/video recorder processor 320, video input converter 328, audio input converter 327, digital audio/video standard interface 326, an audio standard interface 329, audio output converter 330, video output converter 331, HDD microprocessor 120, HDD read channel 115, HDD servo control 116, DVD microprocessor 220, DVD read channel 215, and DVD servo control 216. Power is provided to the circuitry 500 via the single power connector 523. The single power regulator 521 provides power per the required tolerances. The single timing generator 524 provides timing signals to the audio/video recorder processor 320, HDD microprocessor 120, DVD microprocessor 220, and other components. During operation, the single volatile memory 518 is used to temporarily store audio and video data. During non-operation (power-off), the single non-volatile memory 517 is used to store microprocessor commands for the audio/video recorder processor 320, HDD microprocessor 120 and the DVD microprocessor 220.

Description—Operation

The operator of the recorder 10 inputs control commands through the front panel controller 403. The operator may chose to record live broadcast video received by the tuner 402. The recorder processor 320 will draw converted video and audio from the video input converter 328 and audio input converter 327. It can store data temporarily in the volatile memory 518. The recorder processor 320 can then record the data onto the magnetic data disk 111, after processing by the HDD microprocessor 120, HDD read channel 115, and magnetic head 112. Alternatively, the recorder processor could record the data onto the optical data disk 211, after processing by the DVD microprocessor 220, DVD read channel 215, and optical head 212.

The operator can play-back the video data, again inputting commands through the front panel controller 403. The recorder processor 320 can retrieve video data from the magnetic data disk 111, after processing by the magnetic head 112, HDD read channel 115, and HDD microprocessor 120. The recorder processor 320 can also retrieve video data from the optical data disk 211, after processing by the optical head 212, DVD read channel 215, and DVD microprocessor 220. The recorder processor can output the video to the digital audio/video interface connector 303, standard audio interface connector 304, audio output connector 305, or video output connector 306.

The operator can edit the video data stored within the integrated circuitry 500. The recorder processor 320 pulls operator-requested sets of video and audio data from the magnetic disk 111 or optical disk 211 into the volatile memory 518. Acting on commands from the front panel controller 403, the recorder processor 320 can re-sequence, copy or mix the video and audio and then store the data back on the magnetic disk 111. Once editing is complete, the operator can command the recorder processor to record the edited video to the optical data disk 211.

### Description—Additional Embodiments

While the preferred embodiment demonstrates one design of the current invention, many variations exist which may be chosen to optimize integration. For instance, different timing requirements for the audio/video recorder processor, HDD microprocessor, and the DVD microprocessor may necessitate the use of separate timing generator or utilize a timing modifier, such as a divider, for one of the processors. As another example, special volatile memory may be required for the audio/video processor that is different from the volatile memory required of the HDD or DVD functions.

Conclusion:

The present invention advances the prior art by integrating the audio/video recorder processor with HDD and DVD components. The large capacity of magnetic data storage is combined with inexpensive, removable and robust optical data storage. Elimination of redundant components reduces the number of parts to increase reliability, shrink the size, and decrease the cost of the audio/video recorder. Integration of these components creates an audio/video recorder which can easily be subsequently integrated into a final product. This reduces the complexity and development time of the final product.

1. An audio/video recording device, comprising:
a first microprocessor for manipulating audio and video data,
a first disk having a recording surface,
a first spindle motor for rotating said first disk,
a first read or write head for reading data from or recording data to said first disk,
a first positioning mechanism for the first head,
a second microprocessor for controlling the operation of the first head, first positioning mechanism, first spindle motor, and communication with the first microprocessor,
a second spindle motor for rotating a second disk having a recording surface,
a second read or write head,
a second positioning mechanism for the second head,
a third microprocessor for controlling the operation of the second head, second positioning mechanism, second spindle motor, and communication with the first microprocessor, and
a single printed circuit board providing electrical interconnection between the first, second and third microprocessors.

2. An audio/video recorder device of claim 1, wherein the first read or write head for reading data from or recording data to the said first disk uses a magnetic means.

3. An audio/video recorder device of claim 1, wherein the second read or write head for reading data from or recording data to the said second disk uses an optical means.

4. An audio/video recorder device of claim 1, wherein the first read or write head for reading data from or recording data to the said first disk uses a magnetic means, and the second read or write head for reading data from or recording data to the said second disk uses an optical means.

5. An audio/video recorder device of claim 3, wherein the said second disk having a recording surface is a Digital Video Disk (DVD).

6. An audio/video recorder device of claim 4, wherein the said second disk having a recording surface is a Digital Video Disk (DVD).
